(19) United States
(12) Patent Application Publication
(10) Pub. No.: US 2013/0168974 A1
(43) Pub. Date: Jul. 4, 2013

(54) Starter Motor Assembly With Soft Start Solenoid

(71) Applicant: Michael D. Bradfield, Anderson, IN (US)

(72) Inventor: Michael D. Bradfield, Anderson, IN (US)

(73) Assignee: REMY TECHNOLOGIES, LLC, Pendleton, IN (US)

(21) Appl. No.: 13/341,702

(22) Filed: Dec. 30, 2011

(51) Int. Cl. F02N 11/08

(52) U.S. Cl. 290/38 C

(57) ABSTRACT

A solenoid in an engine starter assembly includes an electromagnetic coil operable on a plunger coupled to a shift lever to move a pinion gear into contact with the engine ring gear. The solenoid is provided with a return spring to restore the plunger to an initial position in which the pinion and ring gears are disengaged, in the absence of a coil force. A contact plate is supported on the plunger to engage open electrical contacts when the plunger is in a first position to complete an electrical circuit to drive the starter motor rotating the pinion gear at a faster speed. An over-travel spring resists movement of the plunger once the contact plate engages the electrical contacts. An auxiliary spring is disposed on the plunger to resist movement of the plunger only when the plunger travels to a position offset between the initial position and the first position.

### FIELD

This application relates to the field of vehicle starters, and more particularly, to solenoids for starter motor assemblies.

### BACKGROUND

Starter motor assemblies that assist in starting engines, such as engines in vehicles, are well known. A conventional starter motor assembly is shown in FIG. 8. The starter motor assembly 200 of FIG. 8 includes a solenoid 210, an electric motor 202, and a drive mechanism 204. The solenoid 210 includes a coil arrangement 211 that is energized by a battery upon the closing of an ignition switch. When the coil arrangement 211 is energized, a plunger 216 moves in a linear direction, causing a shift lever 205 to pivot, and forcing a pinion gear 206 into engagement with a ring gear of a vehicle engine (not shown). When the plunger 216 reaches a plunger stop, electrical contacts are closed connecting the electric motor 202 to the battery. The energized electric motor 202 then rotates and provides an output torque to the drive mechanism 204. The drive mechanism 204 transmits the torque of the electric motor through various drive components to the pinion gear 206 which is engaged with the ring gear of the vehicle engine. Accordingly, rotation of the electric motor 202 and pinion gear 206 results in cranking of the engine until the engine starts.

Many starter motor assemblies, such as the starter motor assembly 200 of FIG. 8 are configured with a “soft-start” starter motor engagement system. The intent of a soft start starter motor engagement system is to mesh the pinion gear of the starter into the engine ring gear before full electrical power is applied to the starter motor. If the pinion gear abuts into the ring gear during this engagement, the motor provides a small torque to turn the pinion gear and allow it to properly mesh into the ring gear before high current is applied. The configuration of the solenoid, shift yoke, electrical contacts, and motor drive are such that high current is not applied to the motor before the gears are properly meshed. Accordingly, milling of the pinion gear and the ring gear is prevented in a starter motor with a soft-start engagement system.

Starters with a soft start engagement system, such as that of FIG. 8, typically include a coil arrangement with two distinct coils—a pull-in coil 212 and a hold in coil 214. During operation of the starter, the closing of the ignition switch (typically upon the operator turning a key) energizes both the pull-in coil 212 and the hold-in coil 214. Current flowing through the pull-in coil 212 at this time also reaches the electric motor 202, applying some limited power to the electric motor, and resulting in some low torque turning of the pinion gear. Energization of the pull-in coil 212 and hold-in coil 214 moves the solenoid shaft or plunger in an axial direction. The axial movement of the solenoid plunger moves the shift lever 205 and biases the pinion gear 206 toward engagement with the engine ring gear. Once the solenoid plunger reaches the plunger stop, a set of electrical contacts 220 is closed, thereby delivering full power to the electrical motor. Closing of the electrical contacts effectively short circuits the pull-in coil 212, eliminating unwanted heat generated by the pull-in coil. However, with the pull-in coil is shorted, the hold-in coil 214 provides sufficient electromagnetic force to hold the plunger in place and maintain the electrical contacts in a closed position, thus allowing the delivery of full power to continue to the electric motor 202. The fully powered electric motor 202 drives the pinion gear 206, resulting in rotation of the engine ring gear, and thereby cranking the vehicle engine.

After the engine fires (i.e., vehicle start), the operator of the vehicle opens the ignition switch. The electrical circuit of the starter motor assembly is configured such that opening of the ignition switch causes current to flow through the hold-in coil and the pull-in coil in opposite directions. The pull-in coil 212 and the hold-in coil 214 are configured such that the electromagnetic forces of the two coils 212, 214 cancel each other upon opening of the ignition switch, and a return spring forces the plunger 216 back to its original un-energized position. As a result, the electrical contacts that connected the electric motor 202 to the source of electrical power are opened, and the electric motor is de-energized.

Wear due to gear milling can be a problem for starter gears because the ring gear and pinion gear are typically rotating at different speeds during engagement. In most cases the engine is stopped so the ring gear is not rotating, but the pinion gear is rotating as it is advanced into engagement. In other cases the engine ring gear may be rotating. In these cases the pinion gear is at least initially rotating at a different speed, but even when rotating at the same speed as the ring gear milling still occurs until the gears are meshed. It is desirable to minimize gear milling that occurs in either case. It is also desirable for the pinion gear to be fully engaged to the ring gear before full torque is applied to the pinion gear to start the engine.

### SUMMARY

In one aspect, a starter motor includes a solenoid having three springs—a return spring, a contact over-travel spring and an auxiliary spring. solenoid is provided for a starter assembly of an engine, the assembly having a pinion gear for engaging an engine ring gear, a starter motor for rotating the pinion gear, and a shift lever for shifting the pinion gear from an neutral position out of engagement with the ring gear and an engaged position in engagement with the ring gear. The solenoid includes an electromagnetic coil, open electrical contacts electrically connected to the starter motor, and an elongated plunger slidably disposed relative to the coil, and coupled at one end to the shift lever. The plunger is movable in response to an electromagnetic force from the coil to move from an initial position, corresponding to the neutral position of the pinion gear, to a position corresponding to the engaged position of the pinion gear.

The solenoid further includes a contact plate supported at an opposite end of the plunger and arranged to contact the electrical contacts to complete an electrical circuit when the plunger is in a first position offset from the initial position. Completion of the circuit energizes the starter motor to drive the pinion at a higher speed. In one aspect, the solenoid includes an auxiliary spring configured and arranged relative to the plunger to resist movement of the plunger away from the initial position only when the plunger is at a second position offset between the initial position and the first position. The auxiliary spring thus establishes a controlled stop zone based on a pre-biased spring force of the spring that works against the coil force to stop the plunger travel before the starter motor is fully energized.

In operation of the solenoid, when the coil is energized movement of the plunger away from its initial position is initially resisted only by the return spring. After a certain travel the auxiliary spring is engaged so that the plunger travel is resisted by the combined spring force of the return and auxiliary springs. The combined spring force is greater than the coil force, so that the coil force must be increased for further travel of the plunger. Increasing the current to the coil increases the coil force sufficient to overcome the combined spring force and move the plunger until the contact plate engages the electrical contacts

### DESCRIPTION OF THE FIGURES

FIG. 1 is partial cross-sectional view of a starter solenoid according to the present disclosure.

FIGS. 2a-c are diagrammatic representations of the operation of the starter solenoid illustrated in FIG. 1.

FIG. 3 is a graph of spring force vs. plunger position for a conventional starter solenoid.

FIG. 4 is a graph of spring force vs. plunger position for the starter solenoid shown in FIG. 1.

FIG. 5 is a graph of spring force vs. plunger position and solenoid current for a conventional starter solenoid.

FIG. 6 is a graph of spring force vs. plunger position and solenoid current for the starter solenoid shown in FIG. 1.

FIG. 7 is partial cross-sectional view of a starter solenoid according to a further disclosed embodiment.

FIG. 8 is partial cross-sectional view of a conventional starter solenoid and starter motor arrangement.

### DETAILED DESCRIPTION

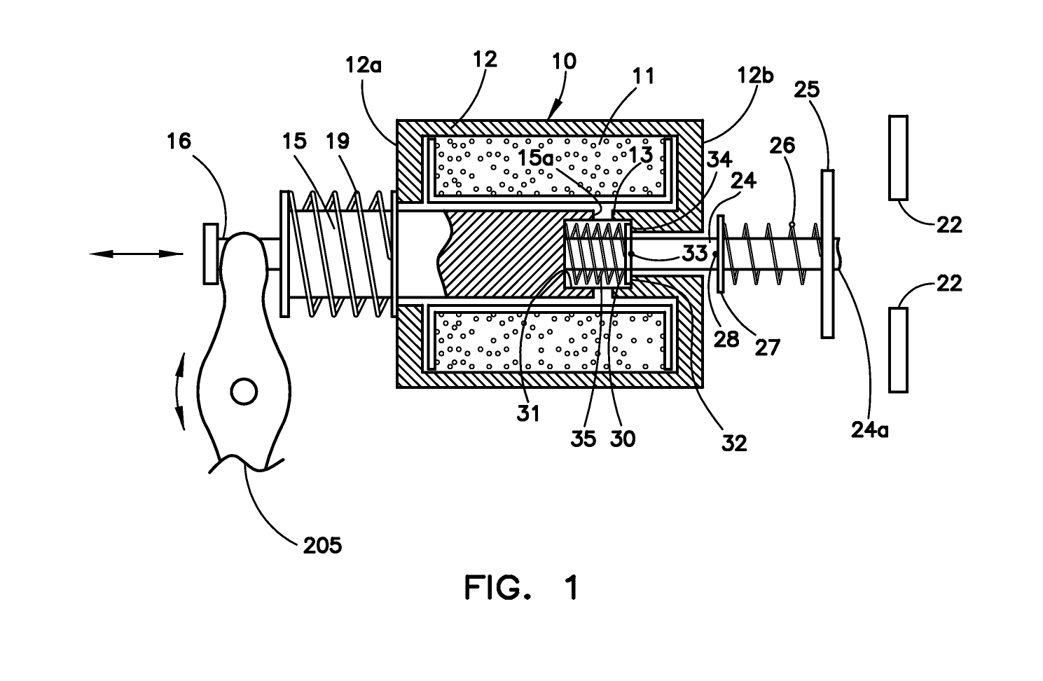

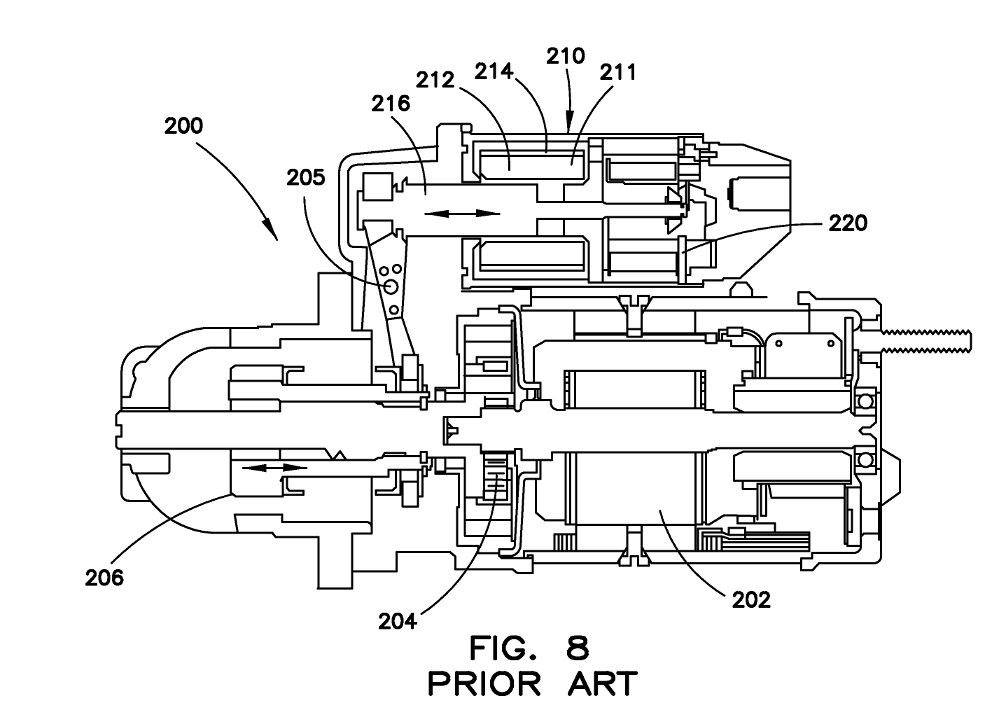

A starter motor solenoid assembly 10 according to one embodiment of the present disclosure is shown in FIG. 1. It is understood that the solenoid assembly 10 may be incorporated into the starter motor assembly 200 of FIG. 8 in lieu of the prior art solenoid 210. Thus, the solenoid assembly 10 is operable to pivot the lever 205 to move the pinion gear 206 into and out of engagement with the engine ring gear, as described above. The solenoid 10 includes a coil 11 housed within a case 12. An armature or plunger 15 extends through the coil and into the case and is coupled to the lever 205 at a shift lever connection 16. The coil 11 may be of various configurations suitable for extending and retracting the plunger 15, as discussed above. The connection 16 between the plunger and lever may be in a variety of forms that are capable of converting translational movement of the plunger 15 into appropriate movement of the lever 205 to shift the pinion gear 206 as described above.

The solenoid assembly 10 includes a biasing element 19 situated between the shift lever connection 16 and a first stop, which may be the end face 12a of the case. The biasing element may be a return spring, as is known in the art, which is configured to bias the plunger to its extended position corresponding to a position of the lever 205 that moves the pinion gear 206 away from engagement with the engine ring gear. When the coil 11 is energized it exerts an electromagnetic force on the plunger 15 tending to retract the plunger into the case, which then pivots the lever to move the pinion gear into engagement with the ring gear. The coil-induced force thus translates the plunger against the force of the biasing element 19. When the coil is de-energized there is no electromagnetic force operating on the plunger, so the biasing element 19 acts as a return spring to restore the plunger to its extended position. The plunger return spring 19 is thus calibrated to exert a return spring force sufficient to pivot the lever 205 and move the pinion gear 206. At the same time, the coil 11 must be at least strong enough to translate the plunger against the force of the return spring 19.

The plunger 15 is also operable to engage electrical contacts (such as the contacts 220) that serve to deliver full power to the starter motor to drive the pinion gear 206, as described above. Thus, as shown in FIG. 1, the plunger 15 includes a rod 24 extending from the plunger through the end face 12b of the case 12 toward electrical contacts 22. A contact plate 25 is mounted to the end of the rod 24 and oriented to make an electrical connection when the plate is pushed against the contacts 22. The contact plate 25 is slidable along the rod 24, with a stop 24a at the end of the rod retaining the plate. A second biasing element 26 is provided that bears against the contact plate 25. The biasing element 26 may be in the form of an over-travel spring that engages the contact plate at one end and a stop plate 27 at its opposite end. The stop plate is held in a fixed position on the rod 24 by a second stop 28, which may be a pin passing through the rod. the biasing element or over-travel spring 26 is “pre-biased”, meaning that the spring is compressed between the contact plate 25 and spring plate 27. The over-travel spring thus exerts a force on the contact plate tending to push it toward the stop 24a. This same force resists movement of the rod 24 through the plate when the plate engages the contacts 22. When the coil 11 is activated it drives the plunger, and thus the contact plate 25 toward the contacts 22. The coil force is optimally calibrated so that plunger and contact plate is moved only until a solid electrical connection is made. As the coil 11 drives the plunger rod 24 toward the contacts 22 once the contact plate 25 engages the contacts the coil force is countered by the pre-biased force of the over-travel spring 26. If this force, combined with the force of the return spring 19, equals the coil force, the plunger will stop. However, if the coil force is greater, further advancement of the plunger and rod 24 will compress the over-travel spring 25 even more between the stop 28 and contact plate 25. The spring force will thus increase until it equilibrates the coil force, at which point the plunger stops advancing.

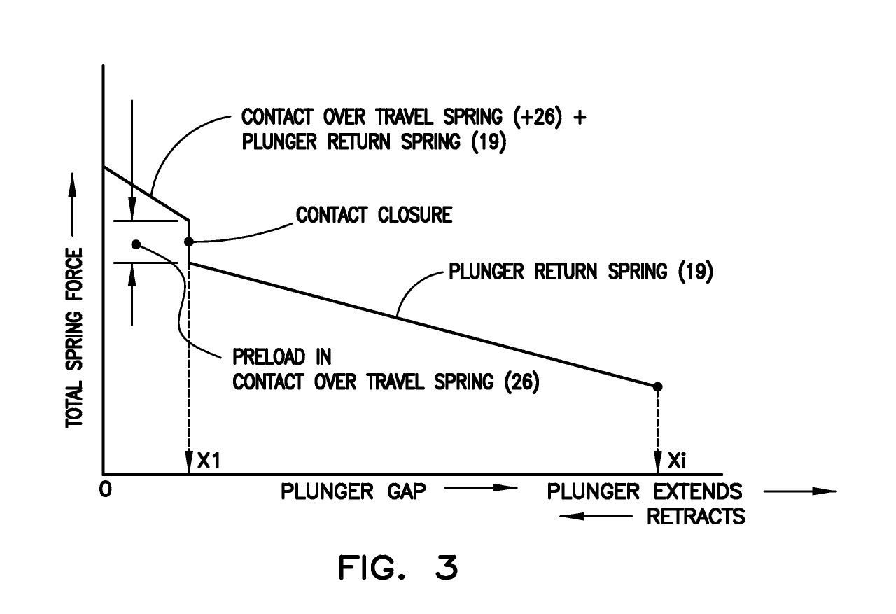

The biasing elements 19 and 26 as thus far described generate a force profile as depicted in the graph of FIG. 3. As shown in this graph, as the plunger retracts into the coil 11 when the coil is energized the coil force is initially resisted only by the return spring force, which increases linearly as a function of the spring constant for the biasing element 19. As reflected in FIG. 3, the return spring is pre-loaded so that at the plunger initial position Xi there is an initial spring force. This pre-biased condition of the return spring ensures that the plunger 15, lever and pinion gear return to their initial position disengaged from the starter ring gear.

As the plunger continues to retract (i.e., as the plunger gap decreases), the contact plate 25 reaches the contacts 22, at the position X1 on the graph. The jump in spring force encountered by the plunger is a reflection of the pre-load in the biasing element 25 (the over-travel spring). This spring force linearly increases according to the spring constant of the over-travel spring until the total spring force is equal to the coil force, or until the plunger 15 bottoms out within the case 12. In this latter case, the case 12 may be provided with an internal boss 13 that is contacted by the end 15a of the plunger 15 to physically halt the movement of the plunger. Thus, contact between the plunger end 15a and the boss 13 can be represented by a plunger gap of 0 in FIG. 3.

When the contacts 22 are closed at position X1 in the graph of FIG. 3, the starter motor is fully energized, as is common in a conventional starter solenoid. This protocol can be problematic in certain circumstances. In one circumstance known as a “soft start”, the engine is to be started from a complete stop. In a soft start condition the pinion gear can grind on the ring gear until the gear teeth manage to mesh. The pinion gear is being pushed into the ring gear by the solenoid 10 and lever 205 while the pinion gear is rotating at full speed. This action causes wear to both the pinion and ring gears, eventually necessitating replacement of one or both of the gears.

In the second circumstance the engine is not stopped completely, so the ring gear is rotating during solenoid engagement. It is desirable to engage the pinion gear to the ring gear as soon as the rotational speed difference is within a predetermined limit so that if/when the driver decides to move the vehicle. Once contact closure occurs (position X1 in FIG. 3) the pinion gear is rotating at full speed which can delay engagement with the ring gear.

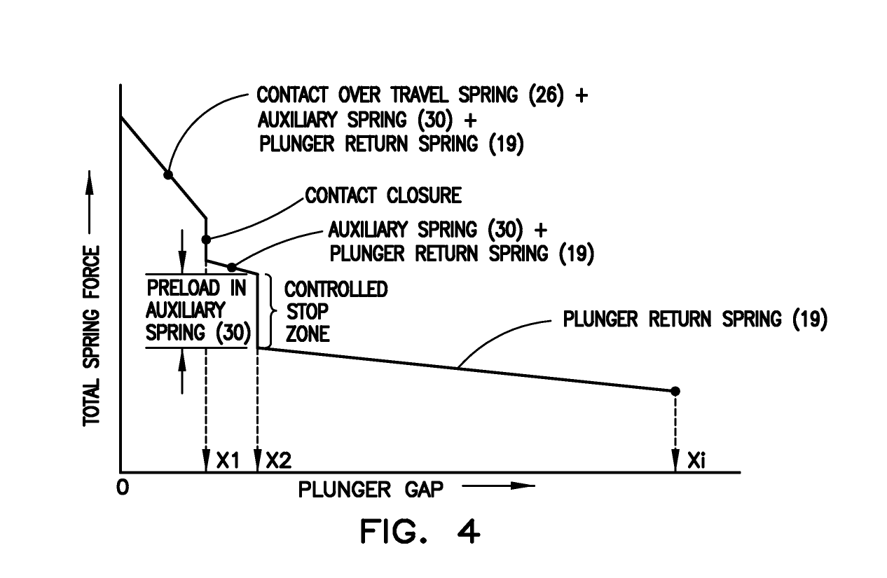

Under either circumstance it is desirable to allow the pinion gear to engage the ring gear at near full depth before full current levels are applied to the starter motor. The conventional solenoid spring arrangement of the return spring 19 and over-travel spring 25 is not able to delay contact closure, as reflected in the graph of FIG. 3. In order to address this problem, the solenoid 10 of the present disclosure introduces an intermediate stop zone prior to contact closure, as depicted in the graph of FIG. 4. In order to achieve this intermediate stop zone, the solenoid 10 is provided, in one embodiment, with an auxiliary biasing element 30 that is disposed between the end 15a of the plunger 15 and the internal boss 13 of the solenoid case 12, as shown in FIG. 1. The biasing element 30 may be a spring that is mounted over the rod 24 of the plunger and is seated within a recess 31 in the end 15a of the plunger. The internal boss 13 of the case 12 may also be provided with a recess 34 to receive the opposite end of the spring 30. The spring bears against a spring plate 32 that in turn initially bears against a third stop 33 fixed to the rod 24. The stop 33 may a pin extending through the rod, similar to the stop 28 described above. The auxiliary spring 30 maybe pre-biased between the recess 31 and the stop 33, or more particularly the stop can be fixed to the rod 24 at a position that partially compresses the spring 30. It should be understood that as the plunger and rod retract within the coil the spring plate 27 contacts the recess 34, even as the stop 33 continues to advance with the rod, thereby compressing the auxiliary spring even further.

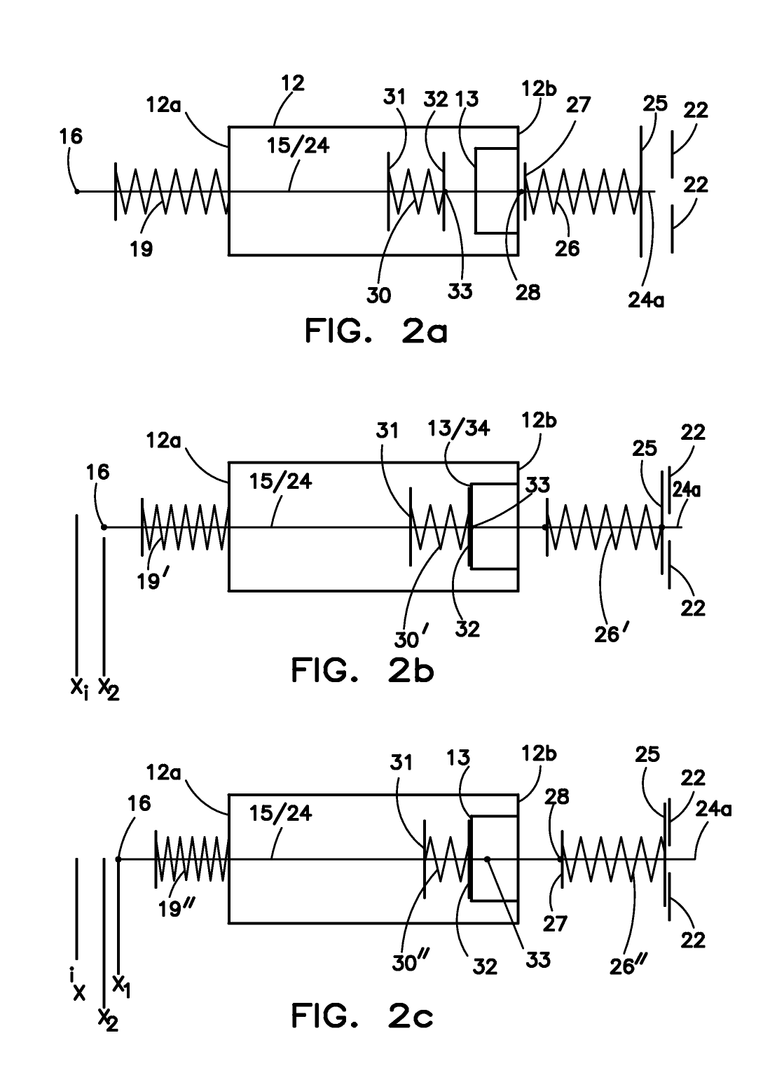

The movement of the plunger/rod and the compression of the three springs 19, 26 and 30 is depicted diagrammatically in FIGS. 2a-2c. The solenoid is shown in its initial position Xi in FIG. 2a in which the plunger is fully extended and the pinion gear is fully disengaged from the engine ring gear. In this position each of the springs 19, 26 and 30 is at its initial pre-biased length. It can be noted that in this position only the return spring 19 is “engaged” or exerting a force reacted by the end face 12a of the casing to push the plunger away from the case. The over-travel spring 26 and auxiliary spring 30 do not bear against any reaction surface and thus do not contribute to the force tending to push the plunger to its initial fully extended position.

When the coil 11 is activated the solenoid plunger is drawn into the coil. When the plunger reaches the position X2 the spring plate 32 for the auxiliary spring contacts the recess 34 in the internal boss 13 of the case 12. At this point, further movement of the plunger is resisted by the auxiliary spring 30′ as well as the return spring 19′, both of which are depressed from their pre-biased lengths. It is important to note that in position X2 the contact plate 25 does not close the circuit with the contacts 22. Thus, the plunger can continue to move or retract an additional distance without driving the starter motor at its full speed. Moreover, the further movement of the plunger from position X2, when the auxiliary spring is engaged, to position X1 when the electrical circuit is completed, is resisted by a greater total spring force than during movement from the initial position Xi. This greater spring force causes the lever 205 to pivot more slowly and thus the pinion gear 206 to move more slowly into engagement with the ring gear, thereby exerting less pressure on the ring gear. The auxiliary spring 30 thus provides a “controlled stop” for the pinion gear that allows the gear to become more fully engaged with the ring gear before full power is applied to rotate the pinion gear. The plunger continues to retract, albeit in a more controlled manner, until the contact plate 25 reaches the contacts 22 at position X1. As explained above, once the contact plate completes the electrical circuit full electrical power is supplied to the starter motor. Moreover, the compressed over-travel spring 26″ adds further resistance to movement of the plunger, which combines with the resistance of the other two springs 19″ and 30″.

These spring forces are reflected in the graph of FIG. 4. As with the conventional starter solenoid, the return spring provides only resistance to the coil force as the plunger moves from the initial position X1. When the plunger has moved to position X2 the auxiliary spring force is added to the return spring force, as reflected by the steeper slope of the force curve between positions X2 and X1 in FIG. 4. When the plunger has traveled the distance to position X1, the over-travel spring force is added so that the force curve is even steeper from position X1 to the zero plunger gap position.

It can be appreciated that the slope of the spring force curve segments depends upon the spring constants of the three springs 19, 26 and 30. The jump in resistance force that occurs at positions X2 and X1 depend upon the pre-load or pre-bias of the auxiliary spring 30 and over-travel spring 26, respectively. This pre-bias is function of the spring constant as well as the location of the corresponding stops 33 and 28. For instance, the pre-bias of the auxiliary spring 35 can be increased by moving the stop 33 closer to the recess 31 in the end 15a of the plunger. Of course, moving the location of the stop 33 on the rod 24 also shifts the position X2 since the plunger must travel farther before the spring plate 32 (which bears against stop 33) contacts the recess 34 in the internal boss 13 of the case. On the other hand, in the configuration shown in FIG. 1, moving the stop 28 for the over-travel spring 26 only changes the pre-bias for that spring and does not alter the travel distance for position X1 (since that distance is determined by the space between the contact plate 25 and the contacts 22 in the initial position of the solenoid).

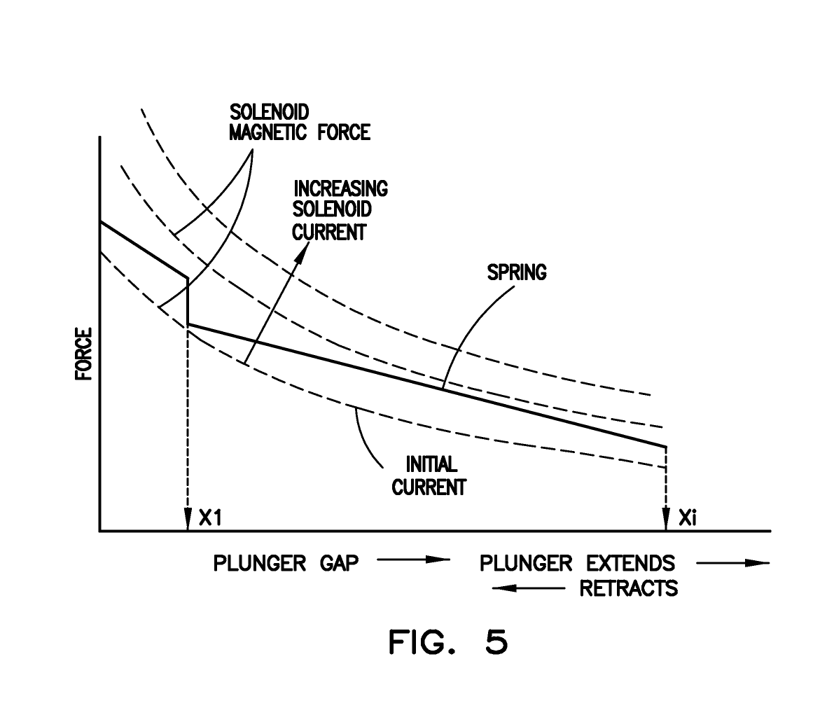

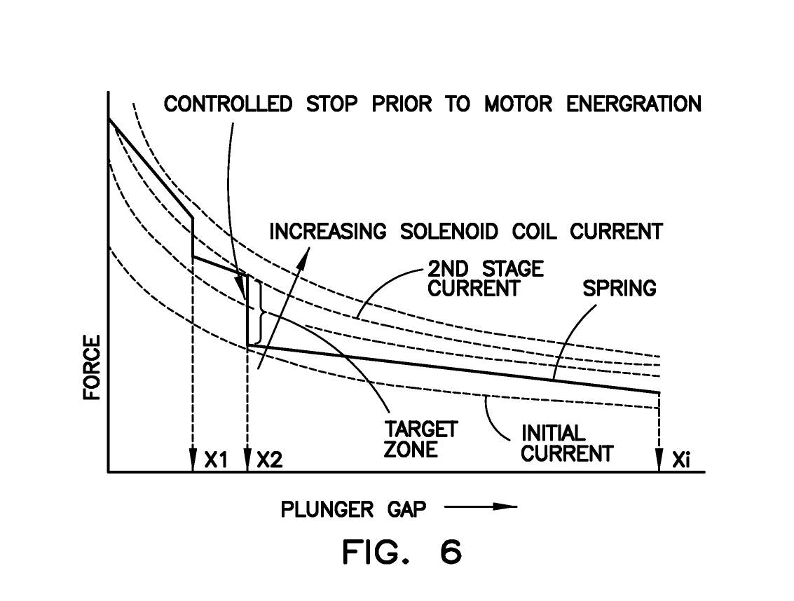

The auxiliary biasing element or spring 30 provides a “controlled stop zone” in which movement of the plunger, and therefore the pinion gear, can be slowed or even temporarily stopped. The plunger movement is dependent upon the resistive forces generated by the springs and upon the advancing force generated by the coil 11. As reflected in FIGS. 5 and 6, the coil force is a function of the current provided to the solenoid 10. In particular, increased current to the coil leads to a greater coil force. The graph in FIG. 5 shows the coil force superimposed on the spring force curves from FIG. 3 that includes only the return spring 19 and the over-travel spring 26. As shown in FIG. 5, when the plunger reaches position X1, the resistive spring force jumps according to the pre-bias of the over-travel spring 26. At the initial current, the solenoid force is insufficient to move the plunger beyond position X1 due to the increase in spring force created by adding the over-travel spring to the return spring. Only with an increase in solenoid current is the solenoid able to move the plunger further from position X1. In the conventional solenoid, as represented by the force curves in FIGS. 3 and 5, there is no need to move the plunger beyond position X1 since it is at that position that the contact plate 25 completes the electrical circuit with the contacts 22.

However, in the solenoid 10 of the present disclosure, the auxiliary spring 30 becomes engaged at position X2, before the contact plate 25 closes the electrical circuit (at position X1). In order to be fully functional the plunger must move beyond position X2 to position X1. At the lowest or initial current the coil force is insufficient to overcome the additional pre-load force of the auxiliary spring, as reflected in FIG. 6. It is only with an increase in coil current, such as to the 2^{nd} stage current line, that the coil force can overcome the combined spring force of the return and auxiliary springs. The coil current between the initial current and the 2^{nd} stage current corresponds to a target zone for the coil current to achieve a controlled stop of the plunger and pinion gear prior to fully energizing the starter motor. As discussed above, this controlled stop allows the pinion gear to become sufficiently engaged with the ring gear before the pinion gear is rotated at its full speed. The solenoid coil current can thus be set at a “controlled stop” value in which the coil force falls within the target zone at the position X2. Thus, when the solenoid is energized the coil force will drive the plunger against the force of the return spring 19 until the plunger reaches position X2 at which the auxiliary spring 30 becomes engaged.

As the pinion gear moves toward the ring gear, the pinion advance will be stopped either by abutment with the ring gear (because the gear teeth have not yet meshed) or will be stopped because the current provided to the coil is only sufficient to generate a coil force in the target zone (FIG. 6). If the pinion gear is stopped by abutment with the ring gear, the reduced current fed to the starter motor is enough to rotate the pinion until the teeth mesh. The pinion gear will then advance into the engagement with the ring gear until the plunger has traveled to the position X2, the predetermined controlled stop point. This controlled stop allows the pinion gear to reach a predetermined axial engagement with the ring gear that is sufficient to accept rotation of the pinion gear at its higher speed. Since the current provided to the coil in the target zone is insufficient to overcome the pre-load force of the auxiliary spring, further advancement of the plunger so that the contact plate 25 can complete the circuit with the contacts 22 requires application of a coil current at or above the 2^{nd} stage current level shown in FIG. 6. At this current the coil force exceeds the combined spring force of the return and auxiliary springs, allowing the plunger and pinion gear to further advance. By the time the contact plate reaches the contacts the pinion gear has been fully engaged with the ring gear and can run at its designed rotational speed without risk to the pinion or ring gears. The solenoid current can be controlled so that it is initially energized at a current within the target zone (FIG. 6) and then subsequently energized at the higher 2^{nd} level current following the controlled stop. An electronic controller may be used to evaluate the engine, starter and starter solenoid conditions to determine when to energize the solenoid at the higher current.

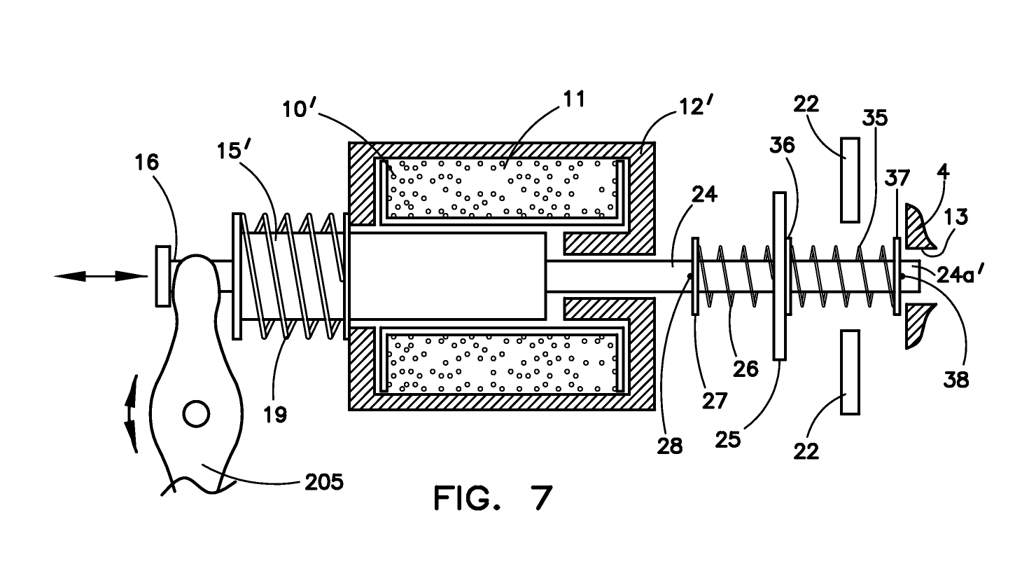

An alternative arrangement of the auxiliary spring is shown in FIG. 7 in which the auxiliary spring is disposed outside the case for the solenoid. In particular, the solenoid 10′ includes a coil 11 and case 12′ similar to the coil and case in the embodiment of FIG. 1. Likewise, the plunger 15′ and rod 24′ are similar, except that the rod 24′ extends beyond the contacts 22. The end 24a′ of the rod can extend into a bore B in a housing component H associated with the starter motor assembly. The solenoid 10′ includes the return spring 19 and over-travel spring 26 arranged as in the previous embodiment. The over-travel spring is disposed between the spring plate 27/stop 28 and the contact plate 25.

The contact plate 25 bears against a spring plate 36 for the auxiliary spring 35, as shown in FIG. 7. The auxiliary spring 35 extends through the gap between the contacts 22 and bears against a second spring plate 37. The second spring plate 37 engages a stop 38 that is fastened to the rod 24′ adjacent the end 24a′. As with the prior auxiliary spring, the auxiliary spring 35 is pre-biased based on the position of the stop 38. More accurately, the over-travel spring 26 and auxiliary spring 35 are pre-biased based on the position of the two stops 28 and 38 because the auxiliary spring plate 36 is in direct engagement with the contact plate 25.

In the arrangement shown in FIG. 7, the coil force is initially resisted only by the spring force of the return spring 19, as in the embodiment of FIG. 1. After the plunger has traveled the distance X2 the spring plate 38 of the auxiliary spring contacts the housing H so that the coil force is resisted by the combination of the return spring and the pre-bias of the auxiliary spring 35. In addition, with the series relationship of the auxiliary and over-travel springs, the coil force is further resisted by the pre-bias of the over-travel spring 26. The auxiliary spring is compressed until the contact plate 25 reaches the electrical contacts 22, at which point the contact plate travel stops. However, further translation of the plunger and rod continues to compress the over-travel spring 26 as the stop 28 and spring plate 27 move toward the contact plate 25.

In the arrangement of FIG. 7, the springs constants of the auxiliary and over-travel springs are coordinated to establish the same controlled stop zone (FIG. 4) or target zone (FIG. 6) so that same coil current can be applied as in the embodiment of FIG. 1. Since the over-travel and auxiliary springs are in series, the force diagram of FIG. 4 will be altered between the positions X2 and X1 because both springs are engaged after position X2. The discrete step at position X1 can be retained with an over-travel spring constant that is much greater than the spring constant of the auxiliary spring. Alternatively, an additional stop may be interposed between the contact plate 25 and auxiliary spring plate 36. This additional stop would isolate the auxiliary spring force from the over-travel spring force throughout the entire travel of the plunger. The force curve in this instance would be similar to FIG. 5 except that the total spring force moving beyond position X1 would only include the return and over-travel spring forces.

It should be understood that pre-biasing forces of the biasing elements (i.e., springs 19, 26, and 35) are a function of the spring constants and by the amount of initial compression. The amount of compression is determined by the location of the associated stops (such as stops 28 and 33). The stops, plunger 15 and rod 24 may be configured to accommodate different stop positions to permit tailoring of the force curve (FIG. 4) when the solenoid is assembled.

In the illustrated embodiments, the biasing elements are disclosed as coil or helical compression springs. However, other resiliently compressible components are contemplated that are capable of generating a force counter to the coil force of the solenoid. The force may be linearly increasing, as depicted in FIGS. 4 and 6, or may be constant throughout the plunger travel. The resiliently compressible element must be capable of being pre-biased so that the plunger encounters an immediate increase in force opposite to the coil force when the particular biasing element is engaged.

The first and second biasing elements or springs disclosed herein are situated outside the case 12. However, other arrangements are contemplated with the corresponding stops in different positions. For instance, the over-travel spring 26 may be sized to extend through the case 12 and internal boss 13, with the second stop 28 positioned inside the case.

In addition, the disclosed embodiments utilize electrical contacts 22 and a contact plate 25 to close the electrical circuit to energize the started motor at its higher level for driving the engine ring gear. However, other arrangements of contacts and contact plate are contemplated. For instance, the contacts 22 may be in the form of a switch and the contact plate 25 may be configured to activate or depress the switch. The contact plate may be appropriately configured provided that it is slidable relative to the plunger/rod and that it is engaged by a biasing element, such as the over-travel spring 26.

The foregoing detailed description of one or more embodiments of a starter motor solenoid assembly been presented herein by way of example only and not limitation. It will be recognized that there are advantages to certain individual features and functions described herein that may be obtained without incorporating other features and functions described herein. Moreover, it will be recognized that various alternatives, modifications, variations, or improvements of the above-disclosed embodiments and other features and functions, or alternatives thereof, may be desirably combined into many other different embodiments, systems or applications. Presently unforeseen or unanticipated alternatives, modifications, variations, or improvements therein may be subsequently made by those skilled in the art which are also intended to be encompassed by the appended claims. Therefore, the spirit and scope of any appended claims should not be limited to the description of the embodiments contained herein

What is claimed is:

1. A solenoid in a starter assembly for an engine, the assembly having a pinion gear for engaging an engine ring gear, a starter motor for rotating the pinion gear, and a shift lever for shifting the pinion gear from an neutral position out of engagement with the ring gear and an engaged position in engagement with the ring gear, said solenoid comprising:
an electromagnetic coil;
open electrical contacts electrically connected to the starter motor;
an elongated plunger slidably disposed relative to said coil, and coupled at one end to the shift lever, said plunger movable in response to an electromagnetic force from said coil to move from an initial position, corresponding to the neutral position of the pinion gear, to a position corresponding to the engaged position of the pinion gear;
a contact plate supported at an opposite end of said plunger and arranged to contact said electrical contacts to complete an electrical circuit when said plunger is in a first position offset from said initial position; and
an auxiliary biasing element configured and arranged relative to said plunger to resist movement of said plunger away from said initial position only when said plunger is at a second position offset between said initial position and said first position.

2. The solenoid of claim 1, wherein said auxiliary biasing element is a spring that is disposed between said plunger and a surface that is in a fixed position relative to said coil, said auxiliary biasing element spring being pre-biased to produce a predetermined spring force greater than the coil force when said plunger is at said second position.

3. The solenoid of claim 2, wherein:
said solenoid includes a case surrounding said coil; and
said surface is a boss defined on said case internal to said coil.

4. The solenoid of claim 2, wherein:
said plunger includes a portion slidably disposed within said coil and a rod extending from said portion to outside said coil;
said solenoid includes a third stop engaged to said rod at a position between said surface and said portion of said plunger to pre-bias said auxiliary spring; and
said auxiliary spring is disposed on said rod between said portion of said plunger and said third stop.

5. The solenoid of claim 2, wherein:
said electrical contacts include a pair of contacts spaced apart by a gap, said pair of contacts disposed between said surface and said coil;
said plunger includes a portion slidably disposed within said coil and a rod extending from said portion outside said coil, through said gap and beyond said pair of contacts;
said solenoid includes a third stop engaged to said rod at a position between said surface and said contact plate; and
said auxiliary spring is disposed on said rod between said contact plate and said third stop.

6. The solenoid of claim 1, further comprising a first biasing element disposed between a first stop and said one end of said plunger, said first stop and said first biasing element configured and arranged to resist movement of said plunger away from said initial position.

7. The solenoid of claim 6, wherein said first biasing element is a spring that is pre-biased to produce a spring force to restore said plunger to said initial position in the absence of a coil force.

8. The solenoid of claim 6, wherein:
said contact plate is slidably disposed on said plunger; and
said solenoid further comprises a second biasing element mounted on said plunger between said contact plate and a stop, said second biasing element and stop configured and arranged so that said second biasing element resists movement of said plunger away from said initial position only when said plunger is in said first position in which said contact plate is in contact with said electrical contacts.

9. The solenoid of claim 8, wherein said second biasing element is a spring that is pre-biased to produce a predetermined spring force when said plunger is in said first position.

10. The solenoid of claim 9, wherein:
said plunger includes a portion slidably disposed within said coil and a rod extending from said portion outside said coil;
said contact plate is slidably mounted on said rod outside said coil;
said spring of said second biasing element is mounted on said rod between said coil and said contact plate; and
said second stop is engaged to said rod at a position outside said coil.

11. The solenoid of claim 1, wherein said auxiliary biasing element is a spring that is disposed between said plunger and a surface that is in a fixed position relative to said coil, said auxiliary biasing element spring being pre-biased to produce a predetermined spring force greater than the coil force when said plunger is at said second position.

12. The solenoid of claim 11, wherein:
said solenoid includes a case surrounding said coil; and
said surface is a boss defined on said case internal to said coil.

13. The solenoid of claim 11, wherein:
said plunger includes a portion slidably disposed within said coil and a rod extending from said portion to outside said coil;
said spring of said auxiliary biasing element is disposed on said rod between said portion of said plunger; and
said solenoid includes a third stop engaged to said rod at a position between said surface and said portion of said plunger to pre-bias said auxiliary spring.

14. The solenoid of claim 10, wherein said auxiliary biasing element is a spring that is disposed between said plunger and a surface that is in a fixed position relative to said case, said auxiliary biasing element spring being pre-biased to produce a predetermined spring force greater than the coil force when said plunger is at said second position.

15. The solenoid of claim 14, wherein:
said solenoid includes a case surrounding said coil;
said surface is a boss defined on said case internal to said coil; and
said auxiliary biasing element is disposed internal to said coil.

16. The solenoid of claim 14, wherein spring of said auxiliary biasing element is disposed on said rod between said portion of said plunger and a third stop engaged to said rod at a position between said surface and said portion of said plunger.

17. A solenoid in a starter assembly for an engine, the assembly having a pinion gear for engaging an engine ring gear, a starter motor for rotating the pinion gear, and a shift lever for shifting the pinion gear from an neutral position out of engagement with the ring gear and an engaged position in engagement with the ring gear, said solenoid comprising:
an electromagnetic coil;
open electrical contacts electrically connected to the starter motor;
an elongated plunger slidably disposed within said coil, and coupled at one end to the shift lever, said plunger movable in response to an electromagnetic force from said coil to move from an initial position, corresponding to the neutral position of the pinion gear, to an engagement position corresponding to the engaged position of the pinion gear;
a contact plate supported at an opposite end of said plunger and arranged to contact said electrical contacts to complete an electrical circuit when said plunger is in a first position offset from said initial position;
a return spring configured and arranged to move said plunger from said engagement position to said initial position in the absence of a coil force;
an over-travel spring configured and arranged to resist movement of said plunger away beyond said first position only when said plunger is at said first position; and
an auxiliary spring disposed between said plunger and a surface fixed in relation to said coil, said auxiliary spring configured to resist movement of said plunger away from said initial position and pre-biased away from said surface to only contact said surface when said plunger is at a second position offset between said initial position and said first position.

18. The solenoid of claim 17, wherein:
said solenoid includes a case surrounding said coil; and
said surface is a boss defined on said case internal to said coil.

19. The solenoid of claim 17, wherein:
said plunger includes a portion slidably disposed within said coil and a rod extending from said portion to outside said coil;
said solenoid includes a third stop engaged to said rod at a position between said surface and said portion of said plunger to pre-bias said auxiliary spring; and
said auxiliary spring is disposed on said rod between said portion of said plunger and said third stop.

20. A method for soft start engagement of a pinion gear of a starter assembly for an engine with the ring gear of the engine, the starter assembly having a starter motor for rotating the pinion gear at a first speed sufficient for partially meshing the pinion and ring gears and at a greater second speed sufficient to start the engine:
activating the starter motor to rotate the pinion gear at a first speed;
providing electrical current to the coil to generate a coil force on the plunger to move the pinion gear into contact with the ring gear;
engaging a biasing member to generate a biasing force resisting and greater than the coil force, thereby stopping the plunger at a position in which the pinion gear and ring gear are partially meshed;
increasing the electrical current to the coil to generate an increased coil force sufficient to overcome the biasing force, thereby moving the plunger to a position in which the pinion gear is fully engaged with the ring gear; and
then activating the starter motor to rotate the pinion gear at the greater second speed.
